(19) United States
(12) Patent Application Publication
(10) Pub. No.: US 2020/0131994 A1
(43) Pub. Date: Apr. 30, 2020

(54) METHOD FOR MODIFYING VALVE ASSEMBLY

(71) Applicant: Hamilton Sundstrand Corporation, Charlotte, NC (US)

(72) Inventors: Richard J. Carpenter, Gales Ferry, CT (US); Scott J. Beloncik, Westfield, MA (US); Aaron F. Rickis, Longmeadow, MA (US); Zachary Allen Ray Le Duc, Rockford, IL (US); Michael Ferrarotti, Durham, CT (US)

(21) Appl. No.: 16/170,299

(22) Filed: Oct. 25, 2018

(51) Int. Cl. F02C 7/232; F02M 59/46; F16K 3/24; F16K 3/30; F16K 11/07

(52) U.S. Cl. CPC F02C 7/232; F02M 59/462; F02M 2200/00; F16K 3/30; F16K 11/0716; F16K 3/24

(57) ABSTRACT

A method of modifying an existing valve assembly has the step of placing a supplemental sleeve within a housing. The housing has a housing inlet window and a housing outlet window, and the supplemental sleeve has a sleeve inlet window and a sleeve outlet window. The method includes the step of placing an existing piston/sleeve set within the supplemental sleeve. A spool valve is also disclosed.

### BACKGROUND

This application relates to a method of creating an adaptor sleeve for an existing valve design to modify the existing valve such that it may be used in a new set of operating conditions, or fit in a larger bore.

Valves are utilized in any number of applications. One standard type of valve is a spool valve wherein a piston may be biased by a spring within a sleeve. There are windows in the sleeve that selectively communicate inlet and outlet ports, as the piston strokes through the sleeve.

Valves are typically designed for a particular application. As an example, the timing and desired flow through a particular valve controls the design of the windows.

However, it may be desirable to utilize a valve designed for one application in a distinct application.

### SUMMARY

A method of modifying an existing valve assembly has the step of placing a supplemental sleeve within a housing. The housing has a housing inlet window and a housing outlet window, and the supplemental sleeve has a sleeve inlet window and a sleeve outlet window. The method includes the step of placing an existing piston-sleeve set within the supplemental sleeve.

A spool valve is also disclosed.

These and other features may be best understood from the following drawings and specification.

### BRIEF DESCRIPTION OF THE DRAWINGS

FIG. 1 schematically shows an existing fuel control system.

FIG. 2A shows a modified system according to this disclosure.

FIG. 2B shows an alternative.

FIG. 3 shows another feature.

### DETAILED DESCRIPTION

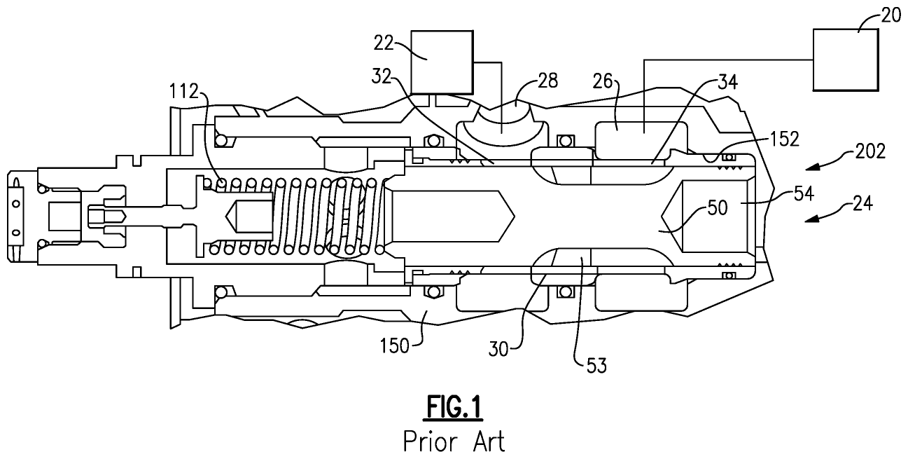

FIG. 1 shows a fuel supply system. A fuel tank and pump 22 selectively sends fuel to a pressure regulating spool valve 24. The fuel enters a chamber 28, and is selectively delivered to a chamber 26 for passage to a downstream fuel system component 20. This is, of course, an oversimplification of a fuel supply system for a gas turbine engine.

The spool valve 24 includes an existing sleeve 30 having an inlet window 32 corresponding to chamber 28 and an outlet window 34 corresponding to chamber 26. A piston 50 is spring-biased by a spring 112 to move along an axis. A window or opening 53 in the piston 50 selectively connects windows 32 and 34. As known, pressurized fluid is supplied to a chamber 54 to cause the spool to move against the force of the spring 112 and control the flow of fluid. Valve 24 can be thought of as an existing valve assembly 202 and fits within a bore 152 in a housing 150.

FIG. 2A shows a supplemental sleeve 100 may be inserted into a bore 252 in a housing 250.

FIG. 2A shows utilizing the existing valve assembly 202 into housing 250 wherein the bore 252 may be radially larger that bore 152 in FIG. 1. To this end supplemental sleeve 100 is inserted into the bore 252 and then the existing valve assembly 202 may be inserted. In some applications the supplement sleeve 100 may be placed about the existing sleeve 30 prior to being inserted.

This allows a valve which has previously been designed for another application to be utilized into this new application and in this larger housing bore. This can allow variation in timing and other characteristics of the valve without requiring a complete design. This can also result in variation in flow characteristics such as flow, volume or pressure.

The piston window 53 would still communicate the existing sleeve inlet window to the existing sleeve outlet window, as originally designed. The supplemental sleeve can either modify a fluid signal such as flow, volume or pressure from the housing inlet window to the existing sleeve inlet window, and/or from the existing sleeve outlet window to the housing outlet window. Alternatively, there need not be any modification in the flow characteristic and merely being received and supported within the large bore is also a benefit of this disclosure.

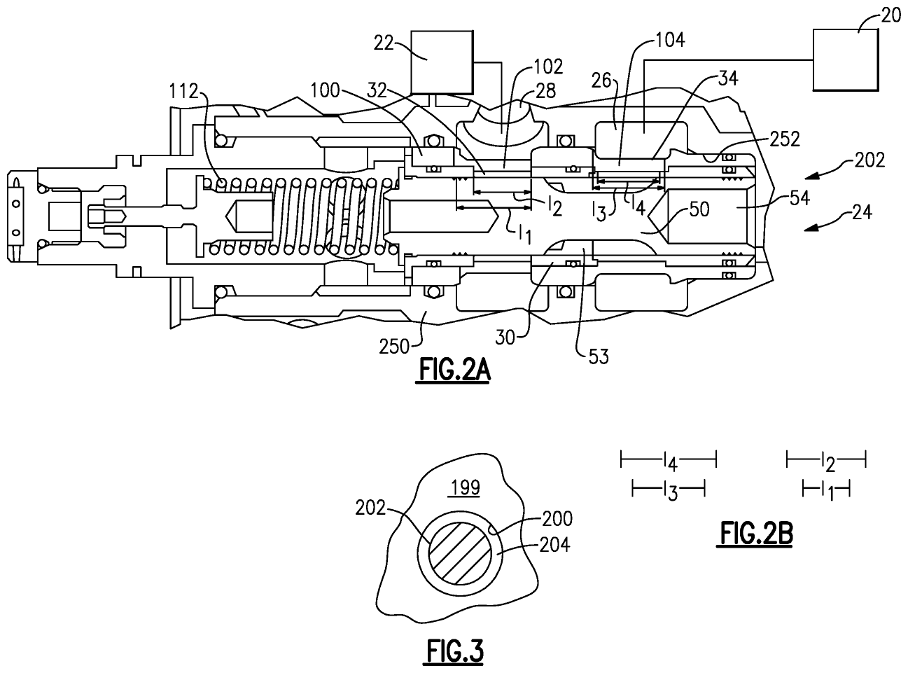

FIG. 3 shows a bore 201 in a housing 199 which has become too large for the existing valve assembly 202. This may occur through manufacturing error, wear, etc. The supplemental sleeve 204 shown here can actually be sized to take up the clearance in such cases, or may be any one of a number of standard sizes.

Also, by utilizing the supplemented sleeve 100, the relative size of the windows 102 and 104 can be changed relative to windows 32 and 34 to achieve a different schedule. As shown, the window 32 has a length 11, while the window 102 has a larger length 12. Similarly, the window 34 has a length 13 whereas the window 104 has a larger length 14. Since the lengths 12 and 14 are shorter than the lengths 11 and 13, the timing and volume of the flow through the valve may be changed to meet a desired application.

One may change the relative sizes of the window to vary the timing of porting from inlet to outlet, or alternatively to maintain existing timing and volume following the modification or repair of the housing.

FIG. 2B shows an alternative wherein the lengths 12 and 14 are longer than the lengths 11 and 13. It may also be true that one of the supplemental sleeve windows is longer than one of the existing sleeve windows, and the other is the opposite.

Using a larger 12 and 14 may provide a same or similar flow volume and pressure, or may slightly modify the pressure drop. It could make the resulting sleeves somewhat lighter. Having a smaller 12 and 14 would allow modifying the performance characteristic of the valve then making windows 102 and 104 in the supplemental sleeve the regulating windows.

While a particular pressure regulating valve for a fuel application in a gas turbine engine is disclosed, the broad teachings of this method could extend to any number of other spool valve and piston valve applications.

A method of modifying an existing valve assembly, comprising the steps of: (a) placing a supplemental sleeve within a housing, wherein the housing has a housing inlet window and a housing outlet window, and the supplemental sleeve has a sleeve inlet window and sleeve outlet window; and
(b) placing the existing valve assembly within the supplemental sleeve.

The housing inlet window and the housing outlet window are formed within the main body of a housing. The valve may be a metering valve, having a spring biasing the piston in one direction with the addition of a secondary pressure signal and a primary fluid pressure selectively biasing the piston in a direction opposed to the spring.

Although an embodiment of this invention has been disclosed, a worker of ordinary skill in this art would recognize that certain modifications would come within the scope of this disclosure. For that reason, the following claims should be studied to determine the true scope and content of this disclosure.

1. A method of modifying an existing valve assembly, comprising the steps of:
(a) placing a supplemental sleeve within a housing bore, wherein the housing has a housing inlet window and a housing outlet window, and said supplemental sleeve has a supplemental sleeve inlet window and supplemental sleeve outlet window; and
(b) placing an existing valve assembly, having an existing sleeve within said supplemental sleeve, and a piston having an opening for selectively communicating the housing inlet window via the supplemental sleeve, and said existing sleeve inlet window to said existing sleeve outlet window and then said supplemental sleeve outlet window and said housing outlet window, and said piston being moveable along an axial direction.

2. The method as set forth in claim 1, wherein said valve is a pressure regulating valve, having a spring biasing said piston in one direction and a fluid pressure selectively biasing said piston in a direction opposed to said spring.

3. The method as set forth in claim 2, wherein said existing valve assembly having an existing flow volume and pressure, and said supplemental sleeve being designed to change at least one of said flow volume and pressure.

4. The method as set forth in claim 1, wherein said existing valve assembly having an existing flow volume and pressure, and said supplemental sleeve being designed to change at least one of said flow volume and pressure.

5. The method as set forth in claim 4, wherein at least one of said supplemental sleeve inlet window and supplemental sleeve outlet window being of a different size than said existing sleeve inlet window and said existing sleeve outlet window to achieve said change in the flow volume or pressure.

6. The method as set forth in claim 5, wherein said existing valve assembly is part of a spool valve in an engine fuel supply system.

7. The method as set forth in claim 6, wherein said housing bore is larger than a desired bore designed to receive said existing valve assembly and said supplement sleeve is designed to take up clearance between an outer periphery of said existing sleeve and an inner periphery of said inner housing bore.

8. The method as set forth in claim 1, wherein at least one of said supplemental sleeve inlet window and supplemental sleeve outlet window being of a different size than said existing sleeve inlet window and said existing sleeve outlet window to achieve said change in the flow volume or pressure.

9. The method as set forth in claim 8, wherein said existing valve assembly is part of a spool valve in an engine fuel supply system.

10. The method as set forth in claim 9, wherein said housing bore is larger than a desired bore designed to receive said existing valve assembly and said supplement sleeve is designed to take up clearance between an outer periphery of said existing sleeve and an inner periphery of said inner housing bore.

11. The method as set forth in claim 1, wherein said housing bore is larger than a desired bore designed to receive said existing valve assembly and said supplement sleeve is designed to take up clearance between an outer periphery of said existing sleeve and an inner periphery of said inner housing bore.

12. A spool valve comprising:
a housing having a bore receiving an outer sleeve with an outer sleeve inlet window and an outer sleeve outlet window;
an inner sleeve within said outer sleeve and having an inner sleeve inlet window and an inner sleeve outlet window;
a piston received within said inner sleeve and spring-biased in an axial direction with said piston having an opening to selectively communicate said inner sleeve inlet window to said inner sleeve outlet window; and
a size of at least one of said inner sleeve inlet window and said inner sleeve outlet window being different than a size of at least one of said outer sleeve inlet window and said outer sleeve outlet window, respectively.

13. The spool valve as set forth in claim 12, wherein said inner sleeve inlet window is axially shorter than said outer sleeve inlet window and said inner sleeve outlet window is axially shorter than said outer sleeve outlet window.

14. The spool valve as set forth in claim 13, wherein said spool valve is part of an engine fuel supply system.

15. The spool valve as set forth in claim 14, wherein said bore is larger than a desired bore designed to receive said inner sleeve, and said outer sleeve being designed to take up clearance between an outer periphery of said inner sleeve and an inner periphery of said bore.

16. The spool valve as set forth in claim 12, wherein said bore is larger than a desired bore designed to receive said inner sleeve, and said outer sleeve being designed to take up clearance between an outer periphery of said inner sleeve and an inner periphery of said bore.

17. The spool valve as set forth in claim 16, wherein said spool valve is part of an engine fuel supply system.

18. The spool valve as set forth in claim 12, wherein said spool valve is part of an engine fuel supply system.

19. A spool valve comprising:
a housing having a bore receiving an outer sleeve with an outer sleeve inlet window and an outer sleeve outlet window;
an inner sleeve within said outer sleeve and having an inner sleeve inlet window and an inner sleeve outlet window;
a piston received within said inner sleeve and spring-biased in an axial direction with said piston having an opening to selectively communicate said inner said inlet window to said inner sleeve outlet window; and
wherein said bore is larger than a desired bore designed to receive said inner sleeve, and said outer sleeve being designed to take up clearance between an outer periphery of said inner sleeve and an inner periphery of said bore.

20. The spool valve as set forth in claim 19, wherein said spool valve is part of an engine fuel supply system.
